(19) United States
(12) Patent Application Publication
(10) Pub. No.: US 2018/0015328 A1
(43) Pub. Date: Jan. 18, 2018

(54) Force Monitoring and Tracking System for Impacts to Tackling Sleds and Punching Bags

(71) Applicant: Daniel Fradin, Fairless Hills, PA (US)

(72) Inventor: Daniel Fradin, Fairless Hills, PA (US)

(21) Appl. No.: 15/649,513

(22) Filed: Jul. 13, 2017

Related U.S. Application Data
(60) Provisional application No. 62/361,524, filed on Jul. 13, 2016.

(51) Int. Cl. A63B 24/00; A63B 69/34; G01P 15/18; A63B 69/20; A63B 69/32; G01L 5/00

(52) U.S. Cl. CPC A63B 24/0062; A63B 69/32; G01L 5/0052; G01P 15/18; A63B 69/201; A63B 69/345; A63B 2225/50; A63B 2220/53

(57) ABSTRACT

A new system of detecting, tracking, and logging force of impact data pertaining to independent impacts to a tackling sled or punching bag is described. The system employs at least one impact sensor, a wireless transmitter, a power source, and a companion application. The at least one impact sensor is equipped with at least one accelerometer configured to accurately detect the force of impact to a pad of the tackling sled or punching bag. The companion application communicates wirelessly to the impact sensor, which relays data to a mobile device or computer running the companion application. A leaderboard can be interfaced with the system, enabling competitive use of multiple impact sensors across multiple punching bags simultaneously.

### CONTIUNITY

This application is a non-provisional application of provisional patent application No. 62/361,524, filed on Jul. 13, 2016, and priority is claimed thereto.

### FIELD OF THE PRESENT INVENTION

The present invention relates to fitness equipment, and more specifically, fitness equipment employed to track and measure the progression and efficacy of practice football tackling, rugby, or other similar sports via the use of a tackling sled or punching bag.

### BACKGROUND OF THE PRESENT INVENTION

High impact athletic sports require players to be in good physical condition, which conventionally requires players to train and practice frequently in order to develop and maintain critical skills to be used during each game. Sports such as American Football and Rugby each require players to come into physical contact with other players, which often includes a player tackling one or more members of the opposing team.

It is known that players of these sports conventionally practice with the use of tackling sleds, which are equipped with one or more pads designed to mimic the stature and resistance of an opposing player to be tackled. Such tackling sleds are often equipped with multiple pads (common configurations include one, two, four, and six pads), each pad designed for use by a single player. Sleds such as these enable coaches to instruct players to tackle the same tackling sled simultaneously, enabling multiple players to practice with the same equipment at the same time. Practicing together as a team in this fashion ensures that players learn to function well as a team/group unit. Training with tackling sleds is especially important for players whose positions require them for rushing or blocking in American Football.

However, when multiple players are practicing on the same multi-padded tackling sled (such as a two-man or four-man tackling sled), it is often difficult to determine the success and efficacy of each individual team member in terms of consistency and registered force of impact during the practice tackle.

Unfortunately, there is currently no effective means of measuring the force of impact on multiple impact sites across a conventional tackling sled. Thus, there is a need for a device that can accurately capture the quantitative, statistical data of a tackling training or practice session (for defensive or rushing players) that employs a conventional tackling sled, so that the practice and prior practices performed by multiple individuals (such as a team) through the use of a multi-padded tackling sled may be generated and recorded for the individuals independently with ease.

Additionally, while force measurement devices exist for punching bags, many are configured to register individual hits based on a variety of sensors, which are either embedded within the punching bag itself, or wrapped around the punching bag. In such cases, the user generally must directly strike the sensor to register the impact. While this is good for installations solely for use on punching bags, these systems are not modular such that they may be removed and used on a tackling sled or similar impact training apparatus. If there were a device that is modular such that it may be installed to tackling sleds or punching bags, users would not need to purchase two separate force measurement devices for both types of workouts.

Thus, there is a need for a system and apparatus that facilitates the tracking of independent impacts to a multi-padded tackling sled. Such a system would preferably be configured with an independent impact sensor designated for each player's segment of the tackling sled (two-man, four-man, six-man sleds). The impact sensors are preferably configured to register impact force, impact duration, and other impact data, and relay the data to a companion mobile device or computer application wirelessly for logging and tracking the data over time.

U.S. Pat. No. 7,858,729 for “Automated Striking and Blocking Trainer with Quantitative Feedback” by Sullivan et al., published on Dec. 28, 2010, shows an automated striking and blocking trainer that gives quantitative feedback. Unlike the proposed invention, Sullivan et al.'s device consists of a frame, a striking body, and a punching bag. Additionally, unlike the present invention, Sullivan does not teach the use of his invention on a conventional tackling sled, nor may it be used by multiple individuals simultaneously.

U.S. Pat. No. 7,308,818 for “Impact-Sensing and Measurement Systems, Methods for Using Same, and Related Business Methods” by Considine et al., issued on Dec. 18, 2007, employs at least one impact-sensor module, a controller module, and a feedback device. Each impact-sensor module can include one or more accelerometers, dynamometers, magnetic-based sensors or other sensors. The impact-sensor modules are attachable to locations on a target such as a dummy, punching bag, etc. Considine does not teach the use of such a system on a tackling sled, not does it indicate use by multiple people simultaneously, such as via use on a four-man tackling sled, unlike the present invention.

U.S. Pat. No. 6,925,851 for “Method and System for Detecting and Displaying the Impact of a Blow” by Reinbold et al., issued on Aug. 9, 2005, shows a system of detecting and displaying force data relating to impacts received on “an item of athletic equipment,” possibly a boxing glove. Each item of athletic equipment has “a force sensor, logic and a wireless transmitter therein, a receiver adapted to receive signals from each of the transmitters, and a processor for formatting the data for display.” In column 12, lines 59-62, the application states, “Examples of athletic equipment in which the sensor may be placed are heavy hitting bags, speed bags, training gloves, bag gloves, punching mitts, hitting targets and shield and body protection . . . .” Reinbold et al.'s invention also calculates factors such as maximum force used. Additionally, Reinbold et al. is not designed to progressively track the progress of a user over time, unlike the present invention.

U.S. Pub. 2010/0307222 for “Measuring Instrument for the Detection and Evaluation of an Impact” by Oberleitner, published on Dec. 9, 2010, shows a measuring device for detecting and evaluating an impact. Oberleitner uses an “impact pad” with at least one force sensor to evaluate an impact, punch, etc., and at least one acceleration sensor. Both sensors are connected to an evaluation unit for processing the detected values. Although the impact pad is described as “in particular for a coaching mitt or hand mitt,” it does appear to have similarities to the present invention, however it differs in that it does not adapt to the progress of the user, nor supply the user with feedback regarding duration, strength, or progress of a practice session.

U.S. Pub. No. 2006/0258515 for “Interactive Virtual Personal Trainer” by Kang et al., published on Nov. 16, 2006, shows a virtual trainer system and method of using such a system. Although Kang et al.'s invention is not a wrap with sensors attached, there are similarities to the proposed invention. In section [0013], Kang et al. is described as having “a plurality of impact sensors [that] are associated on the impact receiving body . . . ” Section [0015] states, “The impact receiving body is typically hollow and formed from a resilient foam material.” Thus Kang et al. employs sensors embedded within a foam material, which is unlike the present invention, which positions a single sensor on the rear of each padded segment of the tackling sled. In addition, Kang et al.'s impact sensor is “capable of measuring data related to an impact force applied to the impact sensor.” However, unlike the present invention, Kang et al. does not employ a similar layout, nor are the strikes registered in a historical fashion to measure progression or regression over time. Additionally, Kang does not teach a device suitable for use on a tackling sled.

U.S. Pub. No. 2003/0216228 for “Systems and Methods of Sports Training Using Specific Biofeedback” by Rast, published on Nov. 20, 2003, shows an apparatus for providing biofeedback sports training. As stated in section [0347], Rast's invention can be use a mesh or a grid of detectors. This is especially useful for golf training, since location of a hit ball can be detected. The concept of a grid of impact sensors seems to bear similarities to the present invention, however the present invention differs in that it is not tailored to the intensity of a tackling training session with a tackling sled, unlike the present invention. Additionally, Rast does not teach the use of multiple iterations of the device across a single piece of sports equipment, such as a tackling sled, to be used by multiple individuals simultaneously, while providing feedback (strength and consistency of force applied) for each individual independently unlike the present invention.

### SUMMARY OF THE PRESENT INVENTION

The present invention relates to a new apparatus and system for tracking the impacts made by players to a tackling sled or punching bag during sports training practice. The present invention employs at least one impact sensor, a power source, and a companion application for use on mobile devices and/or computers. The impact sensors are equipped with at least one accelerometer configured to detect and measure the force of an impact provided by a player tackling/rushing the tackling sled, or punching a punching bag. The impact sensors are configured to be disposed at the rear of the padding of each segment of the tackling sled or punching bag. This is especially useful for tackling sleds configured for use by two, four, six, or more players simultaneously, as each impact sensor can independently register and record the impact provided by each player, allowing the coach to observe the players as a group tackling the sled while also obtaining quantitative data pertaining to each player's impact to the sled individually.

As such, the present invention enables a coach to analyze the data on a mobile device or computer via the companion application, and determine which players provide the most force for blocking or rushing, and which players provide the most consistent force. Additionally, coaches can determine while players tend to trail off after a certain number of repetitive impacts, allowing the coaches to know when it is best to provide specific players rest during a game. This critical data provided to coaches via the companion application may influence how often a player is played in a game, in what combinations of plays, and which side (strong side or weak side) of a lineup.

### BRIEF DESCRIPTION OF THE DRAWINGS

The present invention will be better understood with reference to the appended drawing sheets, wherein:

FIG. 1 exhibits the present invention from the front, detached from a tackling sled or punching bag.

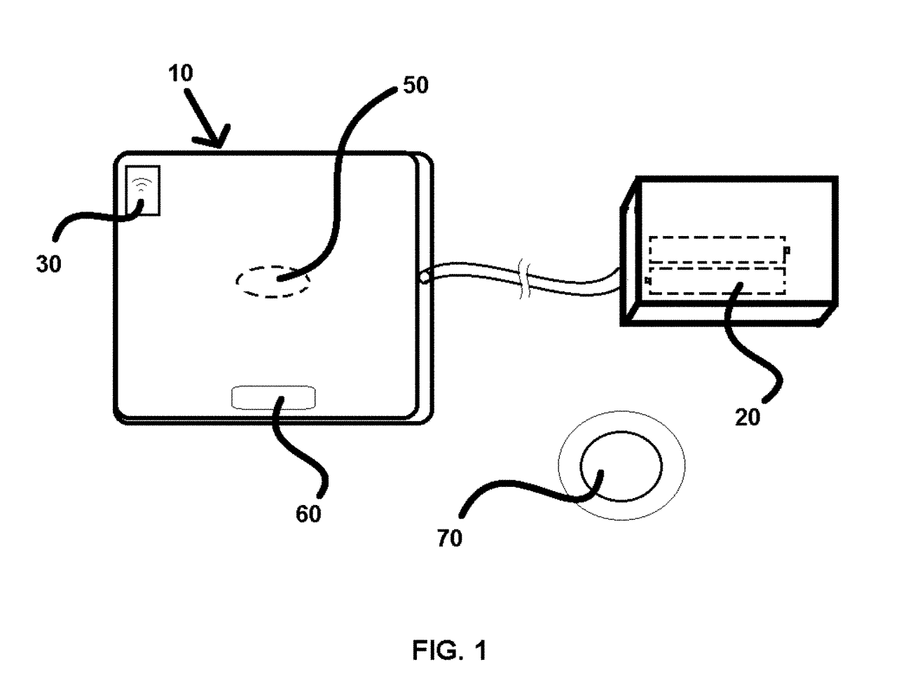

FIG. 2 shows the present invention mounted to a conventional tackling sled, from the front, shown on the rear of the padding of the tackling sled, connected to the metallic frame of the tackling sled.

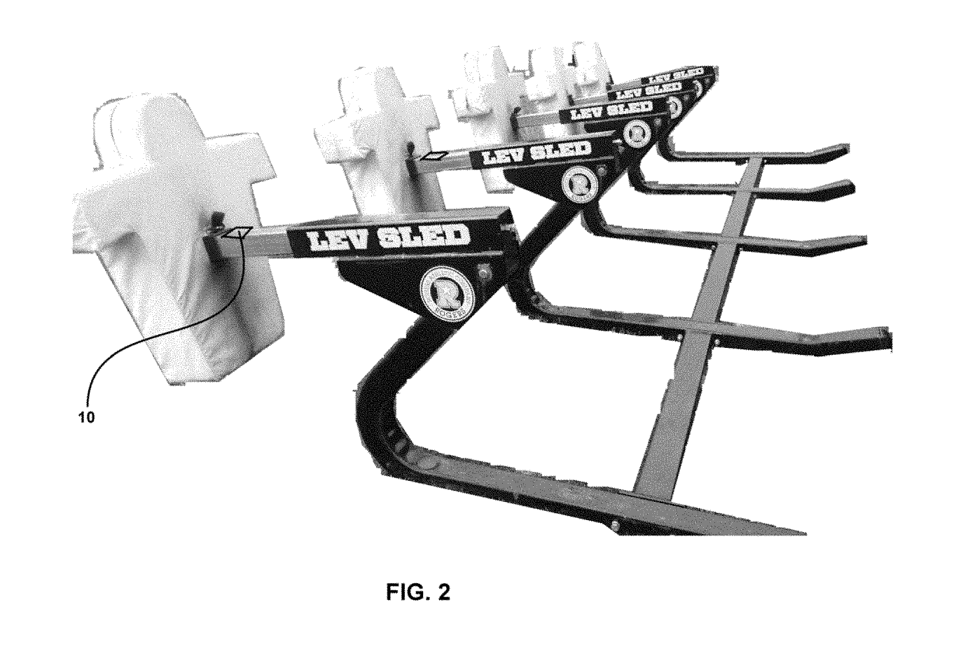

FIG. 3 displays a flow chart depicting the process of use of the present invention in conjunction with the companion mobile device application.

FIG. 4 depicts the companion application of the sled embodiment of the present invention, showing quantitative data pertaining to readings acquired during force impacts to the tackling sled equipped with the present invention.

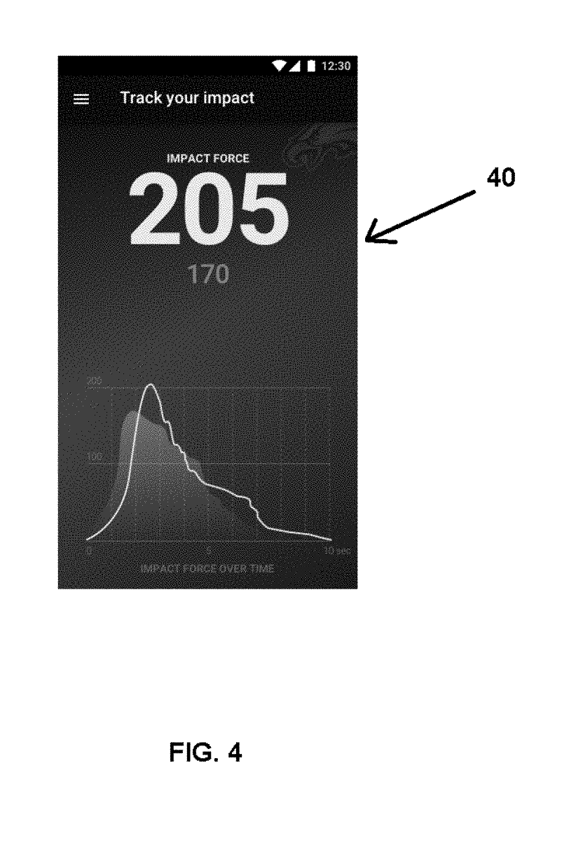

FIG. 5 shows the present invention installed to a punching bag.

FIG. 6 depicts a chart containing the overall system of use of the present invention, complete with multiple installations of the impact sensor across multiple punching bags.

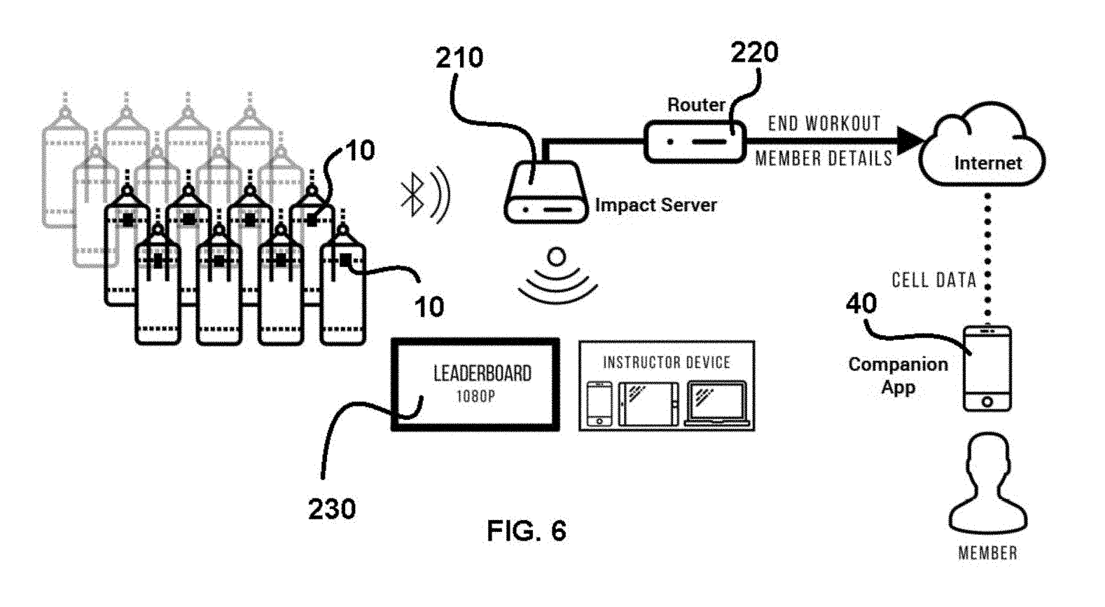

FIG. 7 displays a view of an example leaderboard of the present invention.

FIG. 8 exhibits a screenshot of the companion application of the punching bag embodiment of the present invention.

### DETAILED DESCRIPTION OF THE PREFERRED EMBODIMENT

The present invention is an exercise training tracking device configured for use by high-impact sports players during practice. The preferred embodiment of the present invention consists of multiple components, including at least one impact sensor (10), a power source (20), a wireless transmitter (30), which is preferably a Bluetooth® radio, and a companion application (40). Each impact sensor (10) contains at least one accelerometer (50), which is configured to detect the force of an impact to the tackling sled or punching bag. Additionally, an RFID reader (60) is preferably disposed on or near the impact sensor (10) of the present invention, and is configured to read an RFID tag (70) disposed on or within the shoulder pad of the player training with the tackling sled equipped with the present invention.

The power source (20) of the present invention is preferably AA batteries disposed in a battery housing, and is connected to the impact sensor (10) of the present invention via at least one wire. The power source (20) is configured to power the at least one accelerometer (50) of the impact sensor (10), the RFID reader (60), and the wireless transmitter (30) of the present invention.

The at least one accelerometer (50) embedded within each impact sensor (10) is configured to capture 2-axis motion, namely up/down and back/front. Additionally, the impact sensor (10) is configured to capture the time duration and extent of force applied throughout the entirety of the drive (tackling motion) into the tackling sled. Upon registering an impact, the impact sensor (10) conveys impact data wirelessly via the wireless transmitter (30) to a mobile device or computer equipped with the companion application (40) of the present invention. The companion application (40) then logs the data, and saves the data to a database. The data may be viewed in real-time on the display screen of the mobile device or computer graphically. The data preferably includes the registered force over time, in addition to the highest registered impact during each drive/tackle of the tackling sled. All impacts registered by the impact sensor (10) and conveyed to the companion application (40) on the mobile device or computer are recorded in a history setting that may be viewed by players and coaches at any time after practice.

The companion application (40) of the present invention is preferably equipped with the capacity to easily export any and all impact data pertaining to the team, or pertaining to individual players of the team. The exported data may be compiled in a conventional .CSV file, Microsoft Excel® spreadsheet, or similar format. The data may also be easily emailed to associate coaches or parents from within the companion application (40). Additionally, some embodiments of the companion application (40) may be configured to interface with a cloud-based database on which player historical data may be tracked, stored, and shared more easily.

Some embodiments of the present invention may not be equipped with the RFID reader (60) or RFID tags (70). In such embodiments, the coach must manually enter player numbers and/or names in order to properly map the players' impacts to their identities. This manual data entry pertaining to the players is preferably facilitated via the companion application (40).

It should be understood that multiple impact sensors (10) of the present invention are envisioned to be disposed on tackling sleds designed for use by more than one player. In all embodiments, the impact sensors (10) are installed to the rear of the padding of the tackling sled, with each padded segment equipped with a single impact sensor (10). Therefore, for four-man tackling sleds, the tackling sled is equipped with four impact sensors (10), each configured to independently register, track, and record the impacts to each independent padded segment for each independent player. In such arrangements, coaches are able to watch the entire line of defensive players as a unit while still breaking them down individually per person. It is envisioned that up to seven impact sensors (10) may be deployed for a seven-man tackling sled. This limitation may be overcome with the use of alternative forms of wireless transmitter (30), such as Wi-Fi.

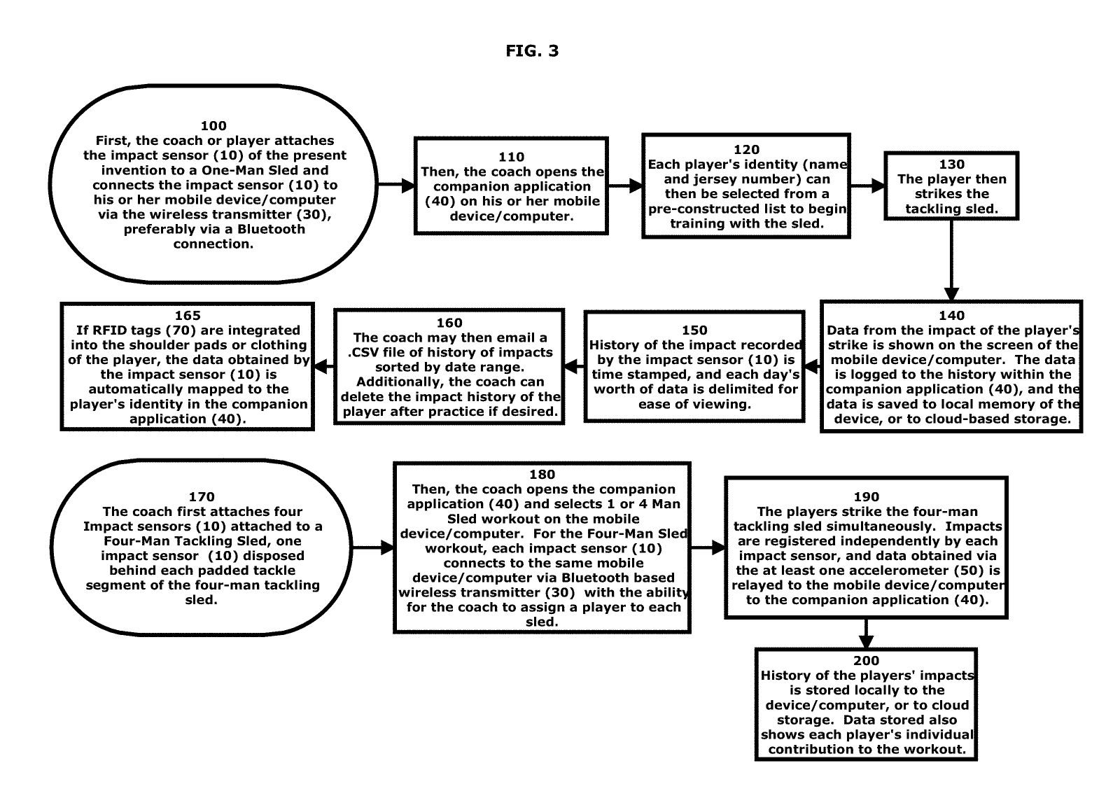

The process of use of the present invention, as depicted in FIG. 3, is preferably as follows:

1. First, the coach or player attaches the impact sensor (10) of the present invention to a One-Man Sled and connects the impact sensor (10) to his or her mobile device/computer via the wireless transmitter (30), preferably via a Bluetooth connection. (100)

2. Then, the coach opens the companion application (40) on his or her mobile device/computer. (110)

3. Each player's identity (name and jersey number) can then be selected from a pre-constructed list to begin training with the sled. (120)

4. The player then strikes the tackling sled. (130)

5. Data from the impact of the player's strike is shown on the screen of the mobile device/computer. The data is logged to the history within the companion application (40), and the data is saved to local memory of the device, or to cloud-based storage. (140)

6. History of the impact recorded by the impact sensor (10) is time stamped, and each day's worth of data is delimited for ease of viewing. (150)

7. The coach may then email a .CSV file of history of impacts sorted by date range. Additionally, the coach can delete the impact history of the player after practice if desired. (160)

It should be noted that, if RFID tags (70) are integrated into the shoulder pads or clothing of the player, the data obtained by the impact sensor (10) is automatically mapped to the player's identity in the companion application (40). (165)

For use of the present invention with a four-man sled:

1. The coach first attaches four Impact sensors (10) attached to a Four-Man Tackling Sled, one impact sensor (10) disposed behind each padded tackle segment of the four-man tackling sled. (170) The impact sensors (10) may be affixed to the metallic frame of the tackling sled.

2. Then, the coach opens the companion application (40) and selects 1 or 4 Man Sled workout on the mobile device/computer. For the Four-Man Sled workout, each impact sensor (10) connects to the same mobile device/computer via Bluetooth based wireless transmitter (30) with the ability for the coach to assign a player to each sled. (180)

3. The players strike the four-man tackling sled simultaneously. Impacts are registered independently by each impact sensor, and data obtained via the at least one accelerometer (50) is relayed to the mobile device/computer to the companion application (40). (190)

4. History of the players' impacts is stored locally to the device/computer, or to cloud storage. Data stored also shows each player's individual contribution to the workout. (200)

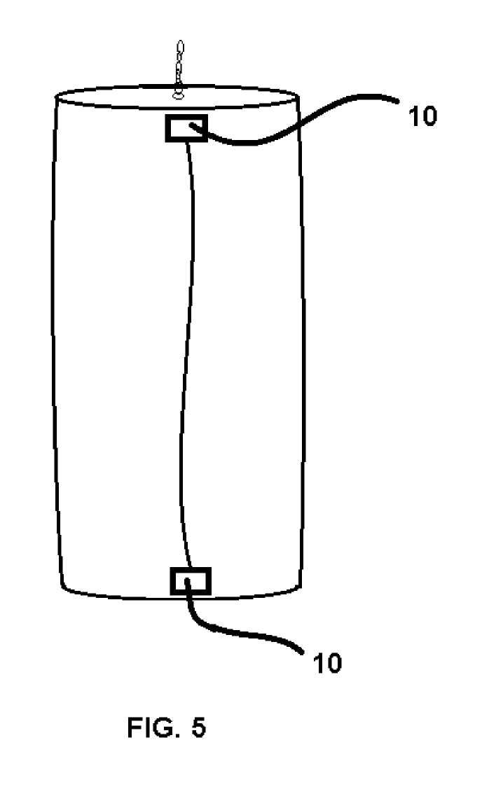

For use of the present invention on a punching bag, as shown in FIG. 5, the process of use is preferably as follows:

1. First, the coach or user installs the impact sensor (10) to the bottom or top of the punching bag, such that it will not be hit directly by the user during practice.

2. Then, the coach or user connects his or her mobile device/computer to the present invention via the wireless transmitter (30), preferably via Bluetooth.

3. The user may then begin his or her workout by striking the punching bag normally.

4. Each strike is registered via the at least one accelerometer (XX) of the impact sensor (10), and the data from the strikes is relayed wirelessly to the companion application (40) running on the mobile device/computer. If an RFID tag (70) is present within the user's wristband or punching glove, the RFID reader (60) of the present invention will read the RFID tag (70) upon impact, and register the impact data to the identity of the user.

5. Statistics and graphical displays of the impact data is shown on the screen of the mobile device/computer running the companion application (40).

6. The impact data is stored locally or to cloud-based storage as history, and is attributed to the user's identity.

The impact sensor (10) installed to the punching bag, in conjunction with the companion application (40) can be configured for multiple users to workout on the same punching bag as well. The coach or instructor simply selects the identity of the user from a list on the screen of the mobile device/computer prior to that user beginning his training workout. If an RFID tag (70) is present, the impact data will automatically be mapped to that user's identity via the RFID reader (60). As such, it should be understood that the present invention may be used by a group of players when installed on either the punching bag or tackling sled(s).

Setup for competitive multi-use of the present invention into a gym environment requires a one-time calibration to each gym's heavy bag setup, unless the style and model of the gym's bags have already been profiled within a similar gym. This profiling gives the system a 90%+ level of accuracy for impact detections. Current members of the gym can be pre-loaded into the system by Impact Wrap and/or gym staff. New members can be added by the gym during the new member onboarding process. Each gym will need to create an account in the App Store and Google Play, if using the app. Instructions can be provided. Monitor(s) placement needs to be determined along with which bags should be shown on each monitor. Additionally, each gym sets the Competition Ratio to be in effect, which can be adjusted at any time.

Few requirements are necessary to implement the system and device of the present invention into a conventional gym. At least one server (210) must be installed, and placed within 30 feet of the bags they are controlling and require a physical Ethernet connection to a router (220). Internet access for the server (210) is needed for uploading app data to the cloud so it can be downloaded into their companion apps. Guest Wi-Fi must be on the same network as the servers (210) for members to reserve a bag via the companion application. At least one 1080p (HD) TV/Monitor should be present and visible to the users of the punching bags to display the leaderboard, which is configured to update in real time. Facebook access is necessary for members to login through this method. Instructions can be provided.

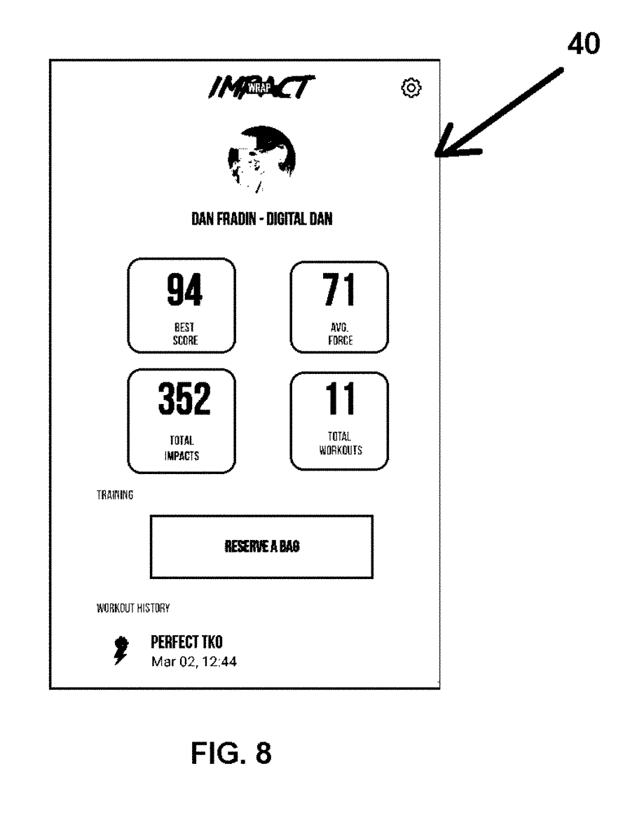

For use in a competitive gym setting, users preferably reserve punching bags that are pre-equipped with the device of the present invention. The reservation process preferably takes place via the companion application (40), as shown in FIG. 8. The process of use of the system and device of the present invention by a user in a competitive gym setting is preferably as follows:

1. Users first reserve a bag at a time of their choosing. It may be during one of an assortment of group workouts, in which several users punch their respective punching bag simultaneously, competing for points. Points are awarded per strike, as well as potentially by the strength of each strike.

2. User then starts the corresponding companion application on his/her mobile device. Users may use the companion app (must be connected to the guest Wi-Fi of the workout establishment), use a gym's provided tablet/computer, or have the staff select which bag to use.

3. The username will be displayed on the leaderboard (230) after connection to the server. The member has the option of just working out without a username and not keeping their history or seeing details. If the member is late, they can just join in on the workout and the staff can assign the bag to them during the workout.

4. The workout then begins. During the workout, the Impact Score is shown on the leaderboard (230) with 1st, 2nd, 3rd place color coded with a trophy badge. The details of the workout are downloaded automatically to the companion app once the workout is complete. A complete history of all workouts is stored in the app.

5. Members then can post their scores on Facebook or email results. They also can opt-in to receive gym alerts and news on their phones.

Little is required in terms of day-to-day maintenance of the system and device of the present invention by gym staff. Preferably, in the morning, gym staff will come and turn on each iteration of the device of the present invention (Impact Wrap) installed on each punching bag of the gym. At the end of the day, or during long breaks, staff should turn off the devices to save power. The staff should also check to make sure the sensors are tight and vertical and adjust the wrap, if necessary. Battery levels are available in the admin screen so no one loses connection mid-workout. A previous workout is loaded (or new one is created) with a countdown timer of 5-15 minutes before the beginning of the workout. This allows users or staff to assign a member to a bag. Users can also be assigned during a workout or immediately afterwards as long as a new workout hasn't started. After each workout, sensors should be checked for correct positioning. Gym staff can push alerts to member's companion apps (i.e. to the mobile devices of users) for promotions or news if needed.

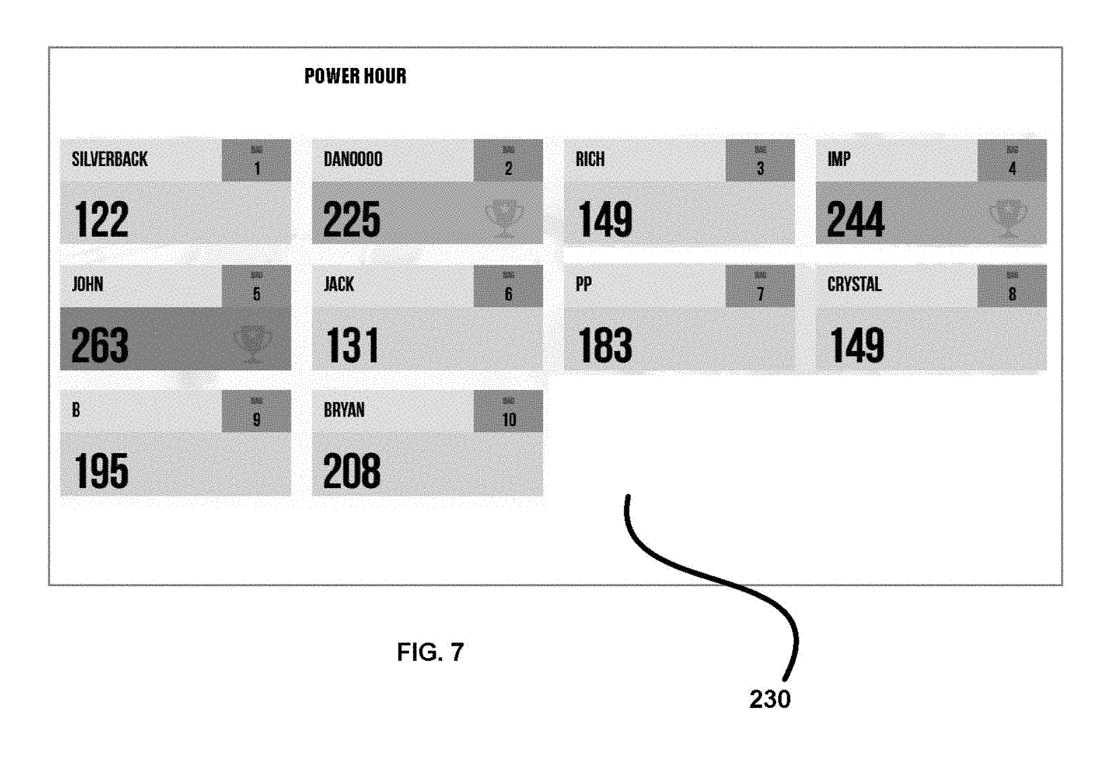

The leaderboard (230) of the present invention can be seen in FIG. 7. First, second and third place dynamically change from gold, silver and bronze to show rank. A trophy badge is also visible. Bag positions never change so it's easy for members/users to see their scores during class. When the workout ends, all scores are shown on the final screen and the top three are highlighted at the top. Bottom scores slide to reveal more users should there be more than 12. Workout details are automatically downloaded to members' companion app. The leaderboard (230) preferably scales in size such that it may display the scores from up to 30 bags (equipped with the present invention) at any time. More monitors can be used to display the scores/strikes of over 30 users simultaneously.

Alternate embodiments of the present invention include variations on the impact sensors (10) included in the product packaging, the size of the impact sensors (10), the shape of the impact sensors (10), and other aesthetic changes. Additionally, the power source (20) may be configured to be a rechargeable battery, which may or may not be removable from the battery housing. It should be understood that the battery housing containing the power source (20) is preferably waterproof to prevent premature wear or damage to the system. Additionally, it is envisioned that the impact sensor (10) is also preferably waterproof.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An impact system, comprising:
at least two impact sensors;
at least two power sources;
a companion application; and
wherein said companion application is configured to measure and compare readings from said at least two impact sensors.
